(19) United States
(12) Patent Application Publication
(10) Pub. No.: US 2010/0145778 A1
(43) Pub. Date: Jun. 10, 2010

(54) CONSUMER COMMERCIAL BEHAVIOR MODIFICATION THROUGH MULTIPLE MERCHANT INCENTIVE PROGRAM

(76) Inventors: Edward W. Fordyce, III, Sedalia, CO (US); Karteek Hasmukh Patel, San Francisco, CA (US); David C. Shepard, Novato, CA (US)

Correspondence Address: Quarles & Brady LLP, TWO NORTH CENTRAL AVENUE, One Renaissance Square, PHOENIX, AZ, 85004-2391, US

(21) Appl. No.: 12/632,136

(22) Filed: Dec. 7, 2009

Related U.S. Application Data
(60) Provisional application No. 61/120,770, filed on Dec. 8, 2008.

(51) Int. Cl. G06Q 30/00; G06Q 40/00

(52) U.S. Cl. 705/14.3

(57) ABSTRACT

A multi-provider rewards program in which rewards are awarded for a series of transactions using an account in a transaction processing system. The transaction processing system includes at least one issuer, at least one acquirer, a plurality of resource providers, a transaction handler, a rewards program rule implementer having access to the rewards program database, and an implementer processor. The implementer processor receives transaction data whenever a transaction occurs using the consumer account, uses the transaction data to determine when a consumer has performed the separate transactions associated with each of a plurality of merchants that are required by a rewards rule and when a consumer has performed the separate transactions with each of the plurality of resource providers, and identifies a reward for the consumer that performed the transactions.

### CROSS-REFERENCE TO RELATED APPLICATIONS

This application claims priority to, and the benefit of, U.S. Provisional Patent Application Ser. No. 61/120,770, filed Dec. 8, 2008, titled “Consumer Commercial Behavior Modification Through Multiple Merchant Incentive Program,” the entire contents of which is hereby incorporated by reference.

### FIELD

The present invention generally relates to changing the commercial behavior of consumers conducting transactions using an account within a payment processing system, and more particularly to incentive programs in which consumers are rewarded for purchasing goods or services with a portable payment device in accordance with incentive program rules.

### BACKGROUND

It is typical for a merchant to have a spend-and-get incentive program in which a ‘punch’ card is used to track transactions made by participating consumers. Each time a consumer makes a qualifying purchase, i.e., a purchase in accordance with rules established for the program, a salesperson punches a hole in, or otherwise marks, the card. After a given number of qualifying purchases have been made, the card can be redeemed for a reward, such as a free product. This type of incentive program, which is a type of consumer loyalty program, requires that the consumer remembers to present the card to the salesperson. In addition, this program is limited to a particular store or a chain of stores.

Patent filings providing examples of loyalty programs include U.S. Patent Application Publication Nos. 20080059306 (“Loyalty Program Incentive Determination,” filed Aug. 30, 2007) and 20080059302 (“Loyalty Program Service”, filed Jun. 22, 2007), U.S. Provisional Patent Application Ser. Nos. 60/824,275 (“Loyalty Programs and Services,” filed Aug. 31, 2006), 60/824,426 (“Method and System for Loyalty Programs and Services,” filed Sep. 1, 2006), 60/915,079 (“Transaction Data Matching,” filed Apr. 30, 2007), and 60/895,111 (“Point of Service Discounting,” filed Mar. 15, 2007). The entire contents of each of the patent documents in this paragraph is hereby incorporated by reference.

A ‘punch’ card-type incentive program is not easily implemented when the manufacturer of a product desires to reward consumers who buy a given quantity of that product regardless of where the purchases occur. Likewise, such a program does not provide a benefit to any other entities in a payment processing system other than the consumer (who gets a free item) and the merchant (which gets repeat business by the consumer). Nor does such a program provide the ability to track consumer commercial behavior beyond a very rudimentary level.

Consumers often pay merchants for goods and services using a payment card account associated with a payment processing system, such as a system operated by VISA U.S.A., Inc. For example, the account may be part of a credit card program, a debit card program, a flexible spending account (FSA) program or a pre-paid card program. These processing systems handle transactions occurring at a large number of merchants located around the world.

Incentive programs, including equivalents of the ‘punch’ card-type incentive program have been developed for use within payment processing systems. For example, prior art incentive programs reward consumers who purchase a certain number of items, or conduct a certain number of transactions with a merchant. However, these programs do not change a consumer's shopping behavior beyond what is accomplished with a ‘punch’ card-type rewards program. Further, these programs do not change a consumer's shopping behavior with respect to multiple merchants providing different goods or services yet linked together in some way such as being in geographic proximity to each other or each having their own incentive programs. Further, conventional payment processing systems heretofore were not easily adaptable for spend-and-get incentive programs involving otherwise unaffiliated stores and/or specific name brand products.

### SUMMARY

One exemplary system is for implementing a multi-provider rewards program wherein rewards are awarded for a series of transactions using an account in a transaction processing system wherein the processing system includes at least one issuer, at least one acquirer, a plurality of resource providers and a transaction handler, the system comprising a rewards program database including rewards program business rules wherein the rewards program business rules require that a consumer perform transactions associated with each of a plurality of resource providers and specify rewards to be awarded upon the consumer performing at least a subset of the transactions associated with each of the plurality of resource providers wherein each of the transactions must be performed using a consumer account associated with the consumer, and a rewards program rule implementer having access to the rewards program database and including an implementer processor, the implementer processor programmed to perform the steps of receiving transaction data whenever a transaction occurs using the consumer account, using the transaction data to determine when a consumer has performed the separate transactions associated with each of the plurality of resource providers and when a consumer has performed the separate transactions with each of the plurality of resource providers, identifying a reward for the consumer that performed the transactions.

In at least some cases the rule implementer is one of a transaction handler and a third party that receives transaction data form the transaction handler for all of the transactions handled by the handler. In at least some cases the transaction handler is a credit card company. In at least some cases the rule implementer communicates with a plurality of different issuers.

In at least some cases each of the transactions includes a purchase of at least one of a product and a service. In at least some cases each of the resource providers is one of a merchant, a manufacturer and a service provider. In at least some cases the business rules require that the separate transactions associated with each of the plurality of resource providers be performed within a time window for a reward to be awarded. In at least some cases each of the transactions includes spending at least a minimum amount with a resource provider.

In at least some cases each transaction includes the consumer spending at least a minimum amount with each of the plurality of resource providers for a reward to be awarded. In at least some cases the resource providers are merchants, each transaction includes the consumer purchasing at least one product/service from a merchant and wherein the business rules require that the consumer spend a total amount greater than a threshold value with the combined plurality of merchants within a specific time window.

In at least some cases, upon determining that a reward should be provided to a consumer, the rule implementer awards the reward. In at least some cases the rule implementer transmits a notice indicating a reward to at least one of the consumer and at least one of the resource providers when a reward is to be awarded.

In at least some cases, upon determining that a reward should be provided to a consumer, the rule implementer identifies entities responsible for funding the reward and transmits funding requests to each of the entities responsible for funding the reward. In at least some cases, after transmitting funding requests to the entities and after the funds are received from the entities, the rule implementer awards the reward. In at least some cases the entities responsible for funding the reward include the plurality of resource providers. In at least some cases the plurality of resource providers each pays an equal percentage of the costs associated with the reward. In at least some cases, pursuant to the rewards program business rules, the consumer spends a total amount with the plurality of resource providers and wherein each of the plurality of resource providers is responsible for a percentage of the total costs associated with the reward that depends on the amount spent with the resource provider in relation to the total amount spent with the plurality of resource providers. In at least some cases the entities responsible for funding the reward include at least one of the transaction handler and at least one of the issuers.

In at least some cases the rule implementer tracks consumer performance of separate transactions and transmits messages to at least one of the consumer and at east one of the plurality of resource providers indicating incomplete activities that need to be completed to obtain the reward. In at least some cases the reward is based on a total amount spent by the consumer with the plurality of resource providers. In at least some cases the business rules require that the consumer purchase product/services from the plurality of resource providers in a specific order.

At least some implementations include a method for implementing a multi-provider rewards program wherein rewards are awarded for a series of transactions using an account in a transaction processing system wherein the processing system includes at least one issuer, at least one acquirer, a plurality of resource providers and a transaction handler, the method comprising the steps of providing rewards program business rules wherein the rewards program business rules require that a consumer perform transactions with each of a plurality of resource providers and specify rewards to be awarded upon the consumer performing at least a subset of the transactions associated with each of the plurality of resource providers wherein each of the transactions must be performed using a consumer account associated with the consumer, receiving transaction data whenever a transaction occurs using the consumer account, using the transaction data to determine when a consumer has performed the transactions with each of the plurality of resource providers and when a consumer has performed the transactions required by the rules, identifying a reward for the consumer that performed the transactions.

Other implementations include a n article of manufacture comprising a computer readable medium having computer readable program code means embodied therein for implementing a multi-provider rewards program wherein rewards are awarded for a series of transactions with a plurality of different resource providers using an account in a transaction processing system wherein the processing system includes at least one issuer, at least one acquirer, a plurality of resource providers and a transaction handler, the computer readable program code means in the article of manufacture comprising computer readable program code means for causing a computer to receive transaction data whenever a transaction occurs using the consumer account, computer readable program code means for causing a computer to use the transaction data to determine when a consumer has performed specific transactions with each of a plurality of resource providers, computer readable program code means for causing a computer to, when a consumer has performed the specific transactions with each of the plurality of resource providers, identify a reward for the consumer that performed the transactions.

### BRIEF DESCRIPTION OF THE DRAWINGS

Implementations of the invention will become more apparent from the description set forth below when taken in conjunction with the drawings, in which like elements bear like reference numerals.

FIG. 1 is a block level diagram illustrating an exemplary payment processing system;

FIG. 2 is a schematic illustrating an exemplary transactions database that may form part of the system shown in FIG. 1;

FIG. 3 is a schematic illustrating an exemplary rewards database that may form part of the system shown in FIG. 1; and

FIG. 4 is a flowchart illustrating an exemplary process designed to modify consumer commercial behavior through incentives offered through a rewards program.

### DETAILED DESCRIPTION

The present concept has particular application to a rewards program that incentivizes specific consumer commercial behavior desirable by entities in a payment processing system. A given rewards program may offer incentives to consumers who use a specific portable payment device associated with an account to purchase specific products or services in accordance with rewards program rules. The given rewards program may be sponsored by one or more merchants such as store chains, a manufacturer or distributor of a brand of products, an issuer of the account and associated portable payment device, a transaction handler processing transactions associated with the account, or a third party interested in modifying consumer commercial behavior. For example, an incentives program may attempt to modify shopping behaviors through rules emulating a scavenger hunt wherein following the rules, including conducting transactions with multiple merchants, results in a predetermined reward. As another example, an incentives program may attempt to modify shopping behaviors through rules requiring a consumer to purchase more than $100 worth of products and services within a two-week time frame from any combination of three separate merchants. As yet one more example, a program may attempt to modify shopping behaviors through rules requiring a consumer to purchase products manufactured/produced by three separate but affiliated manufacturers.

To illustrate, a transaction handler wishing to increase awareness and usage of a new contactless payment technology may team up with a shopping mall operator wishing to modify consumer shopping behavior within their mall to develop and operate a scavenger hunt spend-and-get reward promotion. The transaction handler may want to encourage people to use a new contactless portable payment device, such as a payWave™ credit card offered by VISA U.S.A., Inc. payWave™ is a trademark of VISA U.S.A., Inc. With a scavenger hunt-type rewards program, the mall owner is able to entice consumers into certain, less visited areas of the mall, or visit the mall on less busy days, such as a Monday. Alternatively, a transaction handler or a group of merchants may develop a scavenger hunt or multiple merchant-type rewards promotions in an attempt to modify consumer shopping behavior, such as encouraging the use of a contactless portable payment device to shorten transaction times, reduce manpower, increase traffic, and the like.

Other exemplary incentive programs may be offered to only select consumers, such as those spending more than a certain amount each month in a multitude of stores. Those consumers may be eligible for a given credit, for example, $10.00 USD, off a series of purchases that exceed a predefined amount. Another incentive program may reward selected consumers that purchase a number of particular items from one or more merchants, for example, buying a mattress and pillows results in a free bed spread. Each incentive program has specific rules that must be satisfied before a consumer can receive a reward.

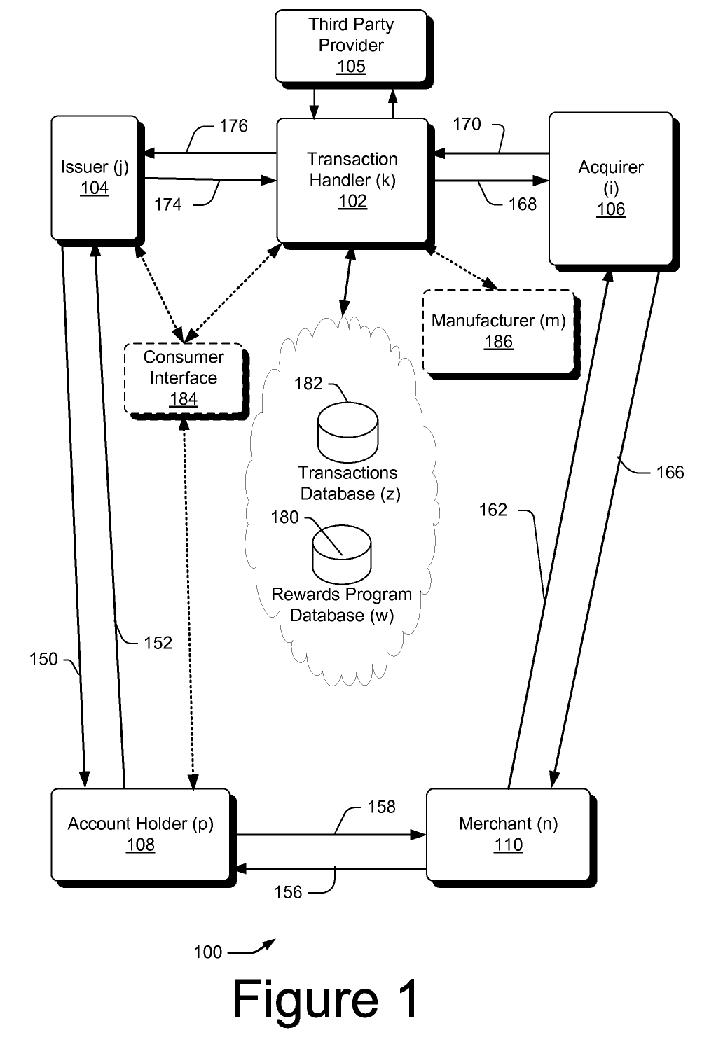

FIG. 1 is a diagram depicting an exemplary financial transaction system 100 that includes, among other entities, at least one transaction handler 102, at least one issuer 104, at least one acquirer 106, at least one card holding consumer 108 and at least one merchant 110 (i.e. a resource provider). In addition, system 100 may include at least one manufacturer or service provider 186 (i.e. a different type of resource provider), a transactions database 182 and a rewards program database 180 as well as at least one consumer interface 184.

An issuer 104 is an entity that issues credit cards or other types of payment devices to consumers, that tracks consumer accounts (e.g., a credit balance) and tracks consumer transactions within the account. For instance, in many cases, an issuer is a bank that may extend a line of credit (e.g., $20,000) to a consumer where the bank periodically sends a credit bill to the consumer to receive reimbursement for funds spent.

An acquirer 106 is a financial organization that processes credit card or other financial transactions for a business and is approved by the transaction handler. Often the acquirer is a bank.

Transaction handler 102(k) is an entity such as a credit card company that operates to link acquirers and issuers together so that acquirers and issuers can communicate between themselves for authorization, clearance and settlement purposes. An exemplary transaction handler is VISA U.S.A., Inc., which handles virtually every transaction in the world that occurs with a VISA brand credit card. In some cases, in addition to facilitating communication between issuers and acquirers, a transaction handler may also perform clearance and settlement steps required to facilitate a transaction.

A resource provider may be a merchant who sells products and/or services provided directly by the merchant or by some other party. In addition, a resource provider may also include a manufacturer or service provider that provides products or services to merchants where the merchants then sell those products or services.

By way of explanation for the nomenclature of reference numerals used in the Figures and described in the specification, a lower case letter in parenthesis is intended to mean an integer variable having a value from 1 to the capital case of the lower case letter, which value can be large (i.e., approaching infinity). Thus ‘(b)’ is intended to mean that the integer ‘b’ can have a value from 1 to B, and ‘(c)’ is intended to mean that the integer ‘c’ can have a value from 1 to C, etc. As such, drawing elements 102, 104, 106, 108, 110, 180, and 182 in FIG. 1 are illustrated as a singular item, but indicate one or more elements may be present. For example, issuer 104(j) is one of a possible plurality of issuers, where j may range from 1 to a large integer. Reward database 180(w) is one of a possible plurality of reward databases each associated with a different rewards program, for example. Furthermore, arrows represent the transfer of money or data, including, but not limited to, financial and non-financial transaction data.

An exemplary retail transaction occurring within the illustrated system 100 begins when a consumer, or account holder 108(p), wishes to pay for goods or services from a merchant 110(n). Merchant 110(n) subsequently presents a total due to the account holder 108(p) (arrow 156). The merchant 110(n) further generates other financial and non-financial transaction data. Other possible financial transaction data includes sales tax, applied discounts such as coupons, and the like. Non-financial transaction data may include the date and time of the transaction, merchant identity, a store identifier, and the like.

Account holder 108(p) then presents a portable payment device to the merchant 110(n) as tender for the transaction. Those of skill in the art will recognize that a portable payment device may be contact-based such as credit, prepaid or debit cards having a magnetic strip and may also be a contactless device such as the payWave™ credit card or payment device. The typical portable payment device includes a volatile or non-volatile memory to store information such as an account number associated with the device and the name of the account holder.

After presenting the portable payment device to the merchant 110(n), data on the device is accessed by the merchant 110(n) in one of a number of ways (arrow 158). Some contactless systems, such as the payWave™ system, employ radio frequency or magnetic fields to read the data stored in the portable payment device. The account information, including an account identifier, is combined with the transaction data, including a total due, to form an authorization request. The authorization request is then transmitted to an acquirer 106(i) associated with the merchant 110(n) (arrow 162). Each acquirer 106(i) is a financial organization that processes credit card transactions for businesses, including merchant 110(n), and is approved by a transaction handler 102(k) such as VISA U.S.A., Inc.

The acquirer 106(i) transmits the authorization request to the transaction handler 102(k) (arrow 170), which in turn routes the request to the issuing bank, or issuer 104(j) of the account holder (p) (arrow 176). The transaction handler (k) maintains a log of authorization requests in transactions database 182(z). The issuer 104(j) approves or rejects the authorization request and returns an approval or rejection message to the transaction handler 102(k) (arrow 174) which relays this information to the merchant 110(n) via the acquirer 106(i) (arrows 168, 166). The merchant 110(n), now knowing whether the account issued by the issuer (j) is valid and supports a sufficient credit balance, completes the transaction. The account holder 108(p) in turn receives the desired goods and/or services in exchange.

To reconcile the financial transactions and provide for remuneration, information about the transaction, including a settlement request, is provided by the merchant 110(n) to the acquirer 106(i) (arrow 162), which in turn routes the settlement request to the transaction handler 102(k) (arrow 170) which then provides the settlement request to the appropriate issuer 104(j) (arrow 176). The issuer 104(j) then provides funding for the transaction to the transaction handler 102(k) (arrow 174) through a settlement bank (not shown). The funds are then forwarded to the appropriate acquirer 106(i) (arrow 168) who in turn pays the merchant 110(n) for the transaction (arrow), less any merchant discount or fees. The issuer 104(j), bills the account holder 108(p) (arrow 150), and in response, the account holder 108(p) pays the issuer 104(j) (arrow 152) with possible interest or fees.

In exemplary implementations described below, an incentive is provided to modify the commercial behavior (such as purchasing habits and/or methods of payment) of consumers, such as account holder 108(p), using an account in the payment processing system 100. As briefly discussed above, a given rewards program may be sponsored by one or more merchants (n, n+1) 110, one or more manufacturers or distributors of a brand of products, an issuer 104(j) of accounts and associated portable payment devices, a transaction handler 102(k or a third party such as the owner of a shopping mall. Each program includes rules dictating conditions or actions that must be complied with to earn a reward. The business rules may be different for each program, but are generally designed to incentivise certain commercial behavior desired by the entities operating the rewards program.

In the case of any rewards or incentive program, one or a subset of the entities runs the program and tracks the information associated therewith such as merchant participants, program/reward rules, consumer participants, consumer transactions that qualify under the rules for rewards, etc. In a general sense virtually any of the issuers, acquirers or transaction handlers could run a rewards program. However, in particularly useful implementations of the inventive systems/methods, a transaction handler or a third party 105 associated with the transaction handler and that can receive all transaction data for all transactions handled by the handler implements the rewards programs.

Advantages associated with having a transaction handler (or associated third party) implement rewards programs are many. First, transaction handlers are in a unique position to implement reward programs using payment devices independent of which issuer issues the devices. To this end, as transactions occur any single issuer only receives transaction data associated with accounts issued by the issuer. Thus, for instance, First Bank only receives transaction data associated with accounts issued by First Bank and does not receive transaction data associated with accounts issued by Second Bank, Third Bank, etc. In contrast, the transaction handler receives transaction data associated with all of the accounts that are affiliated with the transaction handler, For instance, VISA U.S.A., Inc. receives transaction information associated with all VISA branded transactions. Thus, the transaction handler can implement rewards programs for any VISA branded account irrespective of which issuer issued the account.

While the above distinction may not seem particularly important at first blush, in reality the distinction is extremely important. To this end, from a consumer's perspective, where the consumer already has one VISA card, where a rewards program is implemented by a first issuer, if the consumer's current VISA card was not issued by the first issuer, the consumer would have to obtain an additional VISA card issued by the first issuer prior to participating in the rewards program. For many consumers the requirement to obtain an additional card causes the consumers to forego the benefits associated with rewards programs. In contrast, where the transaction handler implements the rewards program, because the handler receives transaction data associated with all accounts affiliated with the handler, the consumer could use the consumer's current VISA card and associated account to participate in the rewards program irrespective of which issuer issued the account.

In addition, where a transaction handler implements rewards programs, a single credit card or other account payment device can be used to participate in many different rewards programs irrespective of which issuer issues a consumer account. For instance, in a case where five different entities or five different groups of merchants want to implement five different rewards programs, each of the entities or groups could set up their programs with a single transaction handler such as VISA U.S.A., Inc., and, regardless of which issuer issues accounts to consumers, any VISA branded account could be used to participate in any or all of the five different rewards programs. In fact, in theory, a single account could be used to participate in an unlimited number of programs with an unlimited number of merchants.

From a merchant's perspective, where a transaction handler implements a merchant's rewards program, the merchant does not have to go through the added expense of, and effort associated with, implementing a co-branded card or payment device program with a specific issuer. Instead, after working with the transaction handler to set up the rewards program, the merchant can simply advertise the rewards program and allow consumers to use any account that is affiliated with the transaction handler that implements the rewards program.

From the perspective of a small merchant (e.g., a mom and pop restaurant) where co-branded cards or payment devices simply do not make sense (e.g., no bank will act as an issuer for a co-branded card with a small restaurant), where a transaction handler implements a rewards program, small merchants can participate or sponsor the program and use virtually any payment device associated with an account affiliated with the transaction handler. Moreover, where the handler implements a program, multiple merchant programs among a plurality of relatively small merchants are possible.

Hereafter, unless indicated otherwise, it will be assumed that the transaction handler 102(k) implements the rewards program although other program implementers are contemplated.

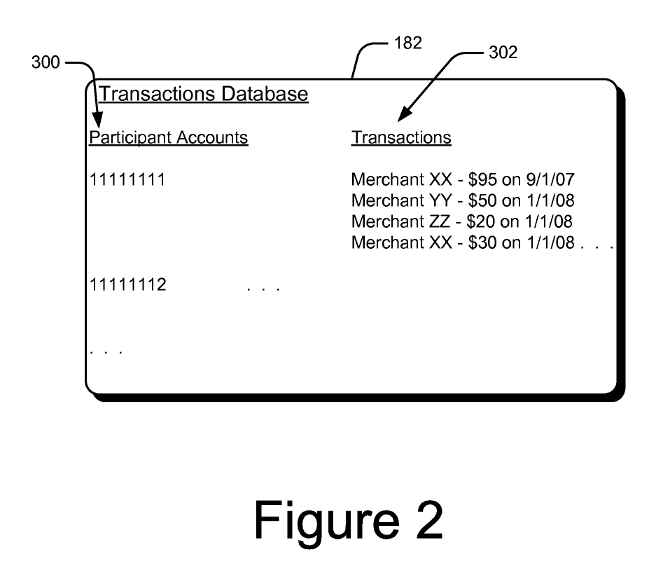

Referring to FIG. 2, an exemplary transactions database 182 is illustrated in a table format. Database 182 includes a participant accounts column 300 and a transactions column 302. As the label implies, accounts column 300 lists all accounts affiliated with the transaction handler 102(k). Exemplary account identifiers include eight-digit numbers 11111111, 11111112, etc. Transactions column 302 lists all transactions that have occurred within a specific period of time prior to the current time (e.g., 12 months) where the period is selected to make sure all transactions that may be relevant to rewards programs are maintained.

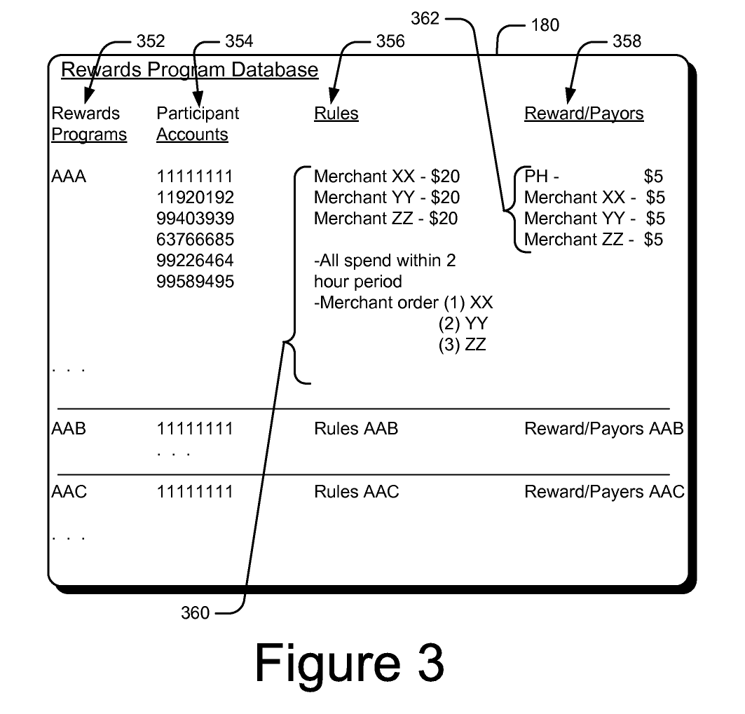

Referring to FIG. 3, an exemplary rewards program database 180 is shown in table format. Database 180 includes three columns including a rewards program column 352, a participant accounts column 354, a rules column 356 and a reward/payors column 358. Programs column 352 lists all rewards or incentives programs that are implemented by the transaction handler 102(k). While only three programs are shown (e.g., AAA, AAB, AAC), it is contemplated that many more (e.g., 1000) programs could be listed in column 352.

Accounts column 354 includes a separate list of consumer accounts for each of the programs in column 352 where each list includes account numbers associated with consumers that are participating in the corresponding program. For instance, exemplary account number “11111111” is provided in the list in column 354 that is associated with program AAA to indicate that the consumer associated with account number 11111111 is participating in program AAA. Note that account number 11111111 also appears in the lists associated with programs AAB and AAC meaning that the consumer associated with account 11111111 is participating in multiple rewards programs.

Rules column 356 lists a separate rule set for each of the rewards programs in column 352. For instance, the rule set 360 for program AAA requires that a consumer spend at least twenty dollars with each of three merchants XX, YY and ZZ within a two hour period beginning with merchant XX, followed by merchant YY and ending with merchant ZZ. This exemplary rule set is referred to herein as a scavenger hunt rule set.

Reward/Payors column lists rewards to be awarded to consumers if their transaction history meets rule requirements for the programs in column 352. For instance, reward 362 indicates that a total of twenty dollars is to be rewarded if the requirements of rule set 360 are met. Column 358 also indicates entities responsible for paying out a reward. Exemplary reward 362 indicates that each of merchants XX, YY and ZZ are responsible for $5 of the twenty dollar reward while handler 102(k) is responsible for the final $5 of the twenty dollar reward.

In the first exemplary implementation and with continued reference to FIG. 1, a scavenger hunt-type incentive program is designed to reward account holders 108(p) conducting a series of transactions with a number of merchants (n, n+1, n+2) 110 in close proximity to each other while using a specific type of portable payment device such as a contactless payment device. Although not necessary, in this implementation it will be assumed that merchants (n, n+1, n+2) 110 and transaction handler 102(k) jointly sponsor (i.e., fund) the rewards program (see rule set 360 in FIG. 3).

Each entity hopes to receive a benefit by modifying the commercial behavior of account holders (p) 180 participating in the program. The transaction handler 102(k), for example, wishes to promote and encourage use of a new portable payment device incorporating contactless payment technology as well as to increase clearance and settlement traffic on the transaction handler's system and to increase the number of consumers opening accounts that are associated with the handler. The merchants (n, n+1, n+2) 110, for example, may wish to increase consumer traffic to their stores, shorten the transaction speed at the checkout, and reduce staffing requirements previously needed to conduct traditional transactions within the payment processing system (e.g., in the case of a contactless payment system.

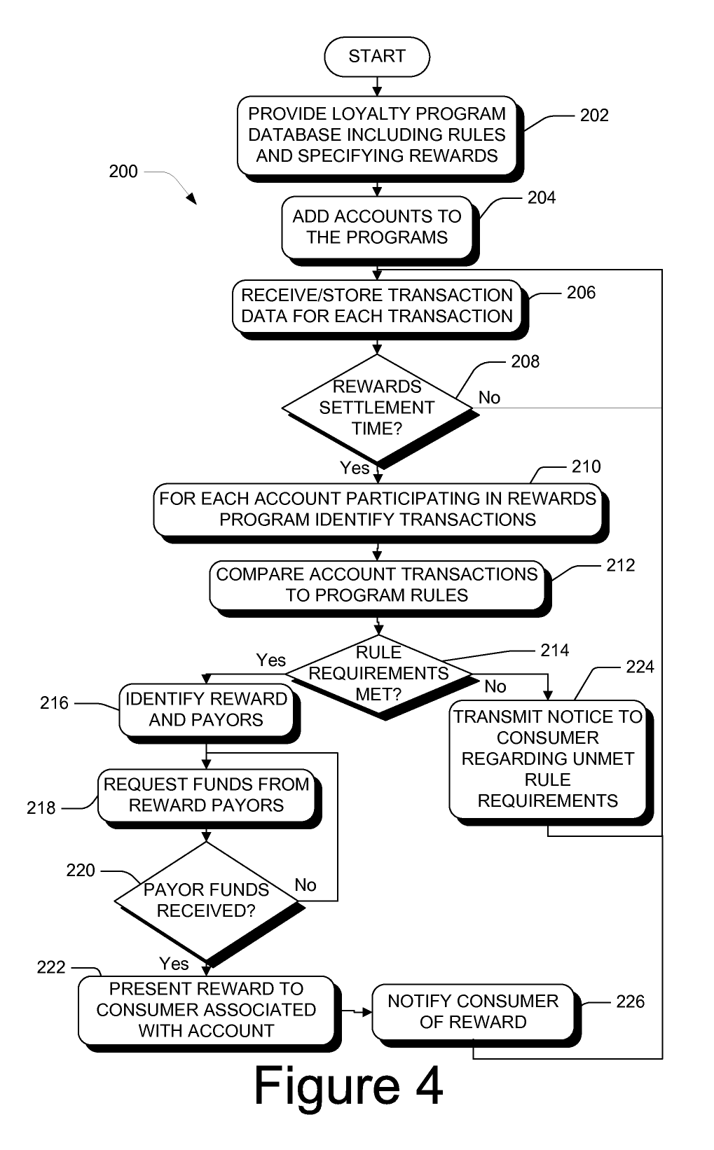

Referring to FIG. 4, an exemplary rewards program process 200 is illustrated. Referring also to FIG. 3, initially at block 202, a rewards program database 180 is provided that specifies rules and associated rewards.

Prior to participating in the scavenger hunt rewards program, an account holder 108(p) is presented with an offer to participate in the program. To participate in the program, the account holder 108(p) must obtain a contactless portable payment device, such as a VISA payWave™ card, associated with an account with any credit card sponsor, or issuer 104(j). When a new account is issued, the account number is added to the transactions database 182 (see FIG. 2). At block 204, the account holder 108(p) registers her account or contactless payment device via a consumer interface 184 (e.g., a browser page presented via a computer display screen) provided by one of the issuers 104(j), the transaction handler 108(p), or by some other business rule implementer (e.g., a third party 105 that may run the rewards programs). Upon registering for a program, the consumer's account number is added to the list of accounts associated with the program in the rewards database (see FIG. 3).

In the present example, consistent with rule set 360 in FIG. 3, it will be assumed that the exemplary scavenger hunt reward program rules require that an account holder 108(p) complete at least one transaction over twenty dollars ($20 U.S.) at each of the three merchants (n, n+1, n+2) 110 in a specific order and within a two hour time period, thus emulating a scavenger hunt. In return for following the scavenger hunt reward program rules exactly, the rules (see 362 in FIG. 3) specify that the account holder 108(p) will receive a twenty dollar ($20.00 US) credit to their account. The reward includes five dollars ($5.00 US) from each of the merchants (n, n+1, n+2) 110 and the transaction handler 102(k) for a total of twenty dollars ($20.00 US).

The account holder 108(p) thus requests and/or registers a contactless payment device that is associated with the consumer's account for inclusion in the rewards program. An account identifier associated with the account holder 108(p) or with the consumer's account is placed in the rewards database 180(w) associated with the specific scavenger hunt incentive program.

The account holder 108(p) proceeds to the first merchant 110(n) and purchases items totaling more than twenty dollars ($20 U.S.) using the contactless payment device. As previously described, transaction data, in the form of an authorization request, is directed from the merchant 110(n) to an associated acquirer 106(i) (arrow 162) and on to the issuer 104(j) via the transaction handler 102(k) (arrows 170, 176). Referring still to FIG. 4, at block 206, at least a portion of the transaction data is stored in transactions database 182(z) by the transaction handler 102(k) (i.e., by the rewards program implementer) so as to be correlated with the account holder's account number. The remaining clearing and settlement of the first transaction occurs as described above.

The account holder 108(p) continues to the second and third participating merchants (n+1, n+2) 110, purchasing items totaling a value of greater than twenty dollars ($20.00 US) at each merchant within the specified time period and using the contactless payment device. Transaction data for both of these purchases is likewise directed to the transaction handler 102(k) via acquirers 106(i+1, i+2) and stored in the transactions database 182(z) (see again process block 206). User interface 186 may be used to provide an indication of the status of account holder 108(p)'s performance in the program.

At block 208, on a daily basis, the transaction handler 102(k) executes a computer implemented process to determine whether the scavenger hunt participants listed in reward database 180(w), including account holder 108(p), have exhibited the commercial behavior desired by the merchants 110(n, n+1, n+2) and the transaction handler 102(k). To this end, at block 210, for each account participating in a rewards program, a processor associated with handler 102(k) identifies transactions (see FIG. 2). At block 212 handler 102(k) compares the account transactions to program rules. At block 214, where rule requirements are not met control passes back up to block 206 where subsequent account transaction date is received and recorded.

In at least some implementations where rule requirements are not met, handler 102(k) may be programmed to formulate and transmit a notice via e-mail or some other communication system indicating unmet rule requirements (see block 224). Here, the notice could be sent in any of several different ways and it is contemplated that handler 102(k) would maintain a database of consumer contact information (e.g., e-mail addresses, phone numbers, etc.) for notice purposes. In some cases the notice may be sent every day regardless of whether or not any of the rule requirements have been met. In other cases notice of unmet requirements may only be set after a minimum subset of transactions required by a rule have occurred. For instance, where a rule requires four transactions within a week, notice of unmet required transactions may be sent at the end of each day after at least two of the required transactions have occurred.

In other systems it is contemplated that notice may also or in addition be provided to one or more merchants regarding unmet rule requirements at block 224. For instance, where a consumer is completing two of three purchases required by a program rule set, during the check out procedure associated with the second purchase, notice may be provided to the second merchant that a third purchase is required to meet the rule requirements. Here the second merchant can provide a verbal reminder to the consumer of the additional purchase required by the rule.

Referring again to block 214 in FIG. 4, if the rule requirements have been met, control passes to block 216 where handler 102(k) identifies a reward. In the present example, if three of the transactions associated with account holder 108(p) satisfy the scavenger hunt program rules, account holder 108(p) is eligible to receive the twenty dollar ($20.00 U.S.) reward as a credit to his account with the issuer 104(j).

In at least some implementations, prior to awarding a reward, the transaction handler (i.e., the rewards program business rule implementer) must first receive the funds from program sponsors to pay for the reward. To this end, and consistent with the payor information specified in the exemplary reward 362 in FIG. 3, at block 216 reward payors are identified. At block 218, funds request messages (arrow 168) for five dollars ($5.00 U.S.) are sent to the respective acquirers 106(i, i+1, i+2) for each of the three merchants 110(n, n+1, n+2). The acquirers 106(i, i+1, i+2) in turn request (arrow 166) and receive (arrow 162) money from the merchants 110(n, n+1, n+2) directly or via a bank account established for the program and send the requested funds to the transaction handler 102(k) (arrow 170). An additional funds request message is generated by and for the transaction handler 102(k) and settled from an internal account for the portion of the reward funded by the transaction handler 102(k).

At block 220, after receiving the funds for the reward, a credit for the twenty dollars ($20.00 U.S.) is transmitted to the issuer 104(j) (arrow 176) at block 222 for fulfillment of the rewards program. The same or progressively higher rewards may be provided to the account-holder 108(p) for subsequent participation in the scavenger hunt program to further reinforce the desired consumer commercial behavior. At block 226 a notice is sent to the consumer indicating that the reward has been awarded.

During or after the life of the scavenger hunt rewards program, the transaction handler 102(k) may use the transactions database 182(z) to track and analyze the commercial behavior of account holders 108(p) enrolled, and not enrolled, in the scavenger hunt rewards program. The analysis may include determining if participation in the scavenger hunt program affected subsequent commercial behavior exhibited by the account holders 108(p) and thus justified the cost associated with the program. The transaction handler 102(k) may also track and analyze all transactions conducted at the sponsoring merchants 110(n, n+1, n+2) during the course of the scavenger hunt program to determine whether the cost of the program was justified, such as by increased business.

In a second exemplary implementation, the rewards program is a multiple merchant (multi-merchant) type rewards program designed to reward consumers for selecting a combination of merchants, including a hotel chain, a car rental chain, and a restaurant chain where each chain has its own ‘frequent user’ programs, over similar merchants while also using a specific portable payment device (e.g., a credit card). In this case the merchants, for example, may wish to increase business.

With continued reference to FIG. 1, prior to participating in the multi-merchant rewards program, an account holder 108(p) is presented with information about the program after applying for a credit card. The program is sponsored by a transaction handler 102(k), such as VISA U.S.A., Inc and three merchants—a hotel chain (merchant 110(n)), a car rental chain (merchant 110(n+1)), and a restaurant chain (merchant 110(n+2)), all of which have multiple locations in various major metropolitan areas. Here it will be assumed that the account holder 108(p) can use any type of payment device affiliated with the transaction handler (e.g., associated with VISA U.S.A., Inc.) including a contact type credit card, a contactless card or device, a cell phone, etc., to participate in the rewards program

In this implementation, the account holder 108(p) does not need to enroll in the multi-merchant program. Instead, by virtue of having a payment device that is associated with a consumer account and that is affiliated with the transaction handler, an account identifier is stored in the multi-merchant program rewards database 180(w+1).

The multi-merchant reward program rules in this case require the account holder 108(p) to conduct the three transactions within a two week period. In return for patronizing the selected merchants 110(n, n+1, n+2) as specified in the program rules, the account holder 108(p) receives a reward of one hundred dollars ($100.00 U.S.) applied to their account.

The account holder 108(p) subsequently takes a trip and uses the services of each of the three merchants 110(n, n+1, n+2) with a contactless payment device within a two week period. As previously described, transaction data including an indication of frequent user program status, is transmitted as part of an authorization message from each of the merchants 110(n, n+1, n+2) to their respective acquirers 106(i, i+1, i+2) (arrow 162) and on to the issuer 104(j) via transaction handler 102(k) (arrows 176, 170). At least a portion of the transaction data from each transaction, including the frequent user program status, is retained in a transactions database (z) 182 (see FIG. 2) for later analysis.

On a regular basis, the transaction handler 102(k) executes a computer implemented process to determine whether the multi-merchant program participants, including account holder 108(p), have exhibited the type of commercial behavior desired by the merchants 110(n, n+1, n+2) and the transaction handler 102(k). Each account identifier in the rewards database (w+1) 180 is matched with transactions in the transaction database (z) 182. Matching transactions are then analyzed, using financial and/or non-financial data, to determine whether the transactions were made in compliance with the multi-merchant program rules. The account holder 108(p) has complied with the multi-merchant program rules and therefore is eligible to receive the one hundred dollar ($100.00 U.S.) reward.

To pay for the multi-merchant program reward, funds request messages for twenty-five dollars ($25.00 U.S.) are sent (arrow 168) to the respective acquirers 106(i, i+1, i+2) of each of the three merchants 110(n, n+1, n+2) which in turn request (arrow 166) and receive (arrow 162) money from the merchants 110(n, n+1, n+2) directly, or via a rewards program bank account. An additional funds request message is generated by the transaction handler 102(k) and settled from an internal account for the portion paid for by the transaction handler 102(k). After receiving the funds to cover the reward, one hundred dollars ($100.00 U.S.) is sent (arrow 176) to the issuer 104(j) associated with the account holder 108(p) and applied as a statement credit (arrow 150) to the account holder 108(p).

In at least some exemplary systems payor responsibility may be dynamic and tied directly or indirectly to the relative amounts a consumer spends with multiple merchants that participate in a multi-merchant rewards program. For instance, where three merchants XX, YY and ZZ participate in a program and a consumer spends $50, $30 and $20 with merchant XX, YY and ZZ, respectively, payor responsibility may be divided up 50%, 30% and 20%, for the merchants XX, YY and ZZ, respectively, (i.e., merchants XX, YY and ZZ would pay $10, $6 and $4, respectively.

As another example, where three merchants participate in a rewards program that credits $20 to a consumer's account after a total of $100 is spent with the three merchants, if the consumer spends $100 with only one or two of the merchants and not the third, the rewards payors may be charged accordingly.

As yet one other example, where three merchants participate in a rewards program, the rules and associated rewards may specify that upon performing a transaction with any one of the merchants the consumer account will be credited five dollars, upon performing transactions with any two of the merchants, the consumer account will be credited fifteen dollars and upon performing transactions with all three merchants, the account will be credited thirty dollars and payor responsibilities can be divided in any agreed upon way.

In another exemplary implementation, a number of manufacturers 186(m, . . . , m+N) may collaborate as resource providers directly with transaction handler 102(k) to offer a multi-manufacturer rewards program. Here, for instance, a rewards program sponsored by a lawn mower manufacturer, a herbicide manufacturer and a herbicide sprayer manufacturer may require purchase of a mower, a specific type and quantity of herbicide and a specific type of sprayer. In this case the rules may allow a consumer to make the required purchases within a three-month window but may not require purchases from specific merchants. Here it is contemplated that transaction data sent to the handler 102(k) or other program implementer would include data useable to identify specific products purchased. In this case, after rules requirements are met, funds would be collected from manufacturers and the reward would be dispersed. In this case the manufacturers operate as resource providers instead of the merchants.

The steps of a method, process, or algorithm described in connection with the implementations disclosed herein may be embodied directly in hardware executing software, in a software module executed by hardware, or in a combination of the two. The various steps or acts in a method or process may be performed in the order discussed, or may be performed in another order. Additionally, one or more process or method steps may be omitted or one or more process or method steps may be added to the methods and processes. An additional step, block, or action may be added in the beginning, end, or intervening existing elements of the methods and processes.

The above description of the disclosed implementations is provided to enable any person of ordinary skill in the art to make or use the disclosure. Various modifications to these implementations will be readily apparent to those of ordinary skill in the art, and the generic principles defined herein may be applied to other implementations without departing from the spirit or scope of the disclosure. Thus, the disclosure is not intended to be limited to the implementations shown herein but is to be accorded the widest scope consistent with the principles and novel features disclosed herein. For instance, while rewards are described as funds credited to a consumer's account above, it should be appreciated that other types of awards are contemplated including but not limited to gifts, bonus points in frequent use programs, discount coupons, etc.

What is claimed is:

1. A network apparatus for implementing a multi-provider rewards program wherein rewards are awarded for a series of transactions using an account in a transaction processing system wherein the transaction processing system includes at least one issuer apparatus, at least one acquirer apparatus, a plurality of resource provider apparatuses, and a transaction handler apparatus, the network apparatus comprising:
a rewards program database apparatus including rewards program business rules wherein the rewards program business rules specify a requirement that a consumer perform transactions associated with each of the plurality of resource provider apparatuses and specify rewards to be awarded upon the consumer performing at least a subset of the transactions associated with each of the plurality of resource provider apparatuses wherein each of the transactions must be performed using a consumer account associated with the consumer; and
a rewards program rule implementer apparatus having access, by hardware executed by software, to the rewards program database apparatus and including an implementer processor apparatus to perform, by hardware executing software, the steps of:
receiving transaction data whenever a transaction occurs using the consumer account;
using the transaction data to determine when a consumer has performed the separate transactions associated with each of the plurality of resource provider apparatuses; and
when a consumer has performed the separate transactions with each of the plurality of resource provider apparatuses, identifying a reward for the consumer that performed the transactions.

2. The network apparatus as defined in claim 1, wherein the rewards program rule implementer apparatus is in communication, by a network, with the transaction handler apparatus and a third party apparatus that receives, by hardware executing software, transaction data from the transaction handler apparatus for all of the transactions handled by the transaction handler apparatus.

3. The network apparatus as defined in claim 2, wherein the transaction handler apparatus comprises a credit card company apparatus.

4. The network apparatus as defined in claim 1, wherein the rewards program rule implementer apparatus communicates with a plurality of different said issuer apparatuses.

5. The network apparatus as defined in claim 1, wherein each of the transactions includes a purchase of at least one of a product and a service.

6. The network apparatus as defined in claim 1, wherein each of the resource provider apparatuses comprises one of (i) the merchant apparatus, (ii) a manufacturer apparatus, and (iii) a service provider apparatus.

7. The network apparatus as defined in claim 1, wherein the rewards program business rules require that the separate transactions associated with each of the plurality of resource provider apparatuses be performed within a time window for a reward to be awarded.

8. The network apparatus as defined in claim 1, wherein each transaction includes the consumer spending at least a minimum amount with each of the plurality of resource provider apparatuses for a reward to be awarded.

9. The network apparatus as defined in claim 1, wherein:
the resource provider apparatuses each comprise a merchant apparatus;
each transaction includes the consumer purchasing at least one product/service from a merchant apparatus; and
the rewards program business rules require that the consumer spend a total amount greater than a threshold value with the combined plurality of merchant apparatuses within a specific time window.

10. The network apparatus as defined in claim 1, wherein, upon determining that a reward should be provided to a consumer, the rewards program rule implementer apparatus, by hardware executing software, awards the reward.

11. The network apparatus as defined in claim 10, wherein the rewards program rule implementer apparatus transmits, by hardware executing software, a notice indicating a reward to at least one of the consumer and at least one of the resource provider apparatuses when a reward is to be awarded.

12. The network apparatus as defined in claim 1, wherein, upon determining that a reward should be provided to a consumer, the rewards program rule implementer apparatus, by hardware executing software, identifies entities responsible for funding the reward and transmits funding requests to each of the entities responsible for funding the reward.

13. The network apparatus as defined in claim 12, wherein, after transmitting funding requests to the entities and after the funds are received from the entities, the rewards program rule implementer apparatus, by hardware executing software, awards the reward.

14. The network apparatus as defined in claim 12, wherein the entities responsible for funding the reward comprise the plurality of resource provider apparatuses.

15. The network apparatus as defined in claim 1, wherein the rewards program rule implementer apparatus, by hardware executing software, tracks consumer performance of separate transactions and transmits messages to at least one of the consumer and at east one of the plurality of resource provider apparatuses indicating incomplete activities that need to be completed to obtain the reward.

16. A method for implementing a multi-provider rewards program wherein rewards are awarded for a series of transactions using an account in a transaction processing system wherein the transaction processing system includes at least one issuer, at least one acquirer, a plurality of resource providers and a transaction handler, the method comprising a plurality of steps each being performed by hardware executing software, wherein the steps include:
providing rewards program business rules wherein the rewards program business rules require that a consumer perform transactions with each of a plurality of resource providers and specify rewards to be awarded upon the consumer performing at least a subset of the transactions associated with each of the plurality of resource providers wherein each of the transactions must be performed using a consumer account associated with the consumer;
receiving transaction data whenever a transaction occurs using the consumer account;
using the transaction data to determine when a consumer has performed the transactions with each of the plurality of resource providers; and
when a consumer has performed the transactions required by the rules, identifying a reward for the consumer that performed the transactions.

17. The method as defined in claim 16 wherein a rule implementer that performs the method is one of a transaction handler and a third party that receives transaction data form the transaction handler for all of the transactions handled by the handler.

18. The method as defined in claim 16 wherein the business rules require that the separate transactions associated with each of the plurality of resource providers be performed within a time window for a reward to be awarded.

19. The method as defined in claim 16 further including the steps of, upon determining that a reward should be provided to a consumer, identifying entities responsible for funding the reward and transmitting funding requests to each of the entities responsible for funding the reward.

20. An article of manufacture comprising a computer readable medium having computer readable program code embodied therein for causing hardware executing the computer readable program code embodied in the computer readable medium to implement a multi-provider rewards program wherein rewards are awarded for a series of transactions with a plurality of different resource providers using a consumer account in a transaction processing system, wherein the transaction processing system includes at least one issuer, at least one acquirer, a plurality of resource providers and a transaction handler, wherein the computer readable program code embodied in the computer readable medium includes:
computer readable program code means for causing a computer to receive transaction data whenever a transaction occurs using the consumer account;
computer readable program code means for causing a computer to use the transaction data to determine when a consumer has performed specific transactions with each of a plurality of resource providers; and
computer readable program code means for causing a computer, when a consumer has performed the specific transactions with each of the plurality of resource providers, to identify a reward for the consumer that performed the transactions.

21. The article of manufacture as defined in claim 20, wherein a rule implementer that implements the multi-provider rewards program is one of the transaction handler and a third party that receives transaction data from the transaction handler for all of the transactions handled by the transaction handler.

22. The article of manufacture as defined in claim 20, wherein the computer readable program code embodied in the computer readable medium includes further includes computer readable program code means for causing a computer to, upon determining that a reward should be provided to a consumer, identify entities responsible for funding the reward and transmit funding requests to each of the entities responsible for funding the reward.

23. The article of manufacture as defined in claim 20, wherein the computer readable program code embodied in the computer readable medium includes further includes computer readable program code means for causing a computer to track consumer performance of separate transactions and transmit messages to at least one of the consumer and at least one of the plurality of resource providers indicating incomplete activities that need to be completed to obtain the reward.
